(19) United States
(12) Patent Application Publication
(10) Pub. No.: US 2007/0231603 A1
(43) Pub. Date: Oct. 4, 2007

(54) PERMANENT MAGNETIC CIRCUIT, AXISYMMETRIC MAGNETIC FIELD GENERATING METHOD, AND MANUFACTURING METHOD FOR PERPENDICULAR MAGNETIC RECORDING MEDIUM

(75) Inventor: Ken OHASHI, Tokyo (JP)

Correspondence Address: ROBERTS, MLOTKOWSKI & HOBBES, P. O. BOX 10064, MCLEAN, VA, 22102-8064, US

(73) Assignee: SHIN-ETSU CHEMICAL CO., LTD., Tokyo (JP)

(21) Appl. No.: 11/694,234

(22) Filed: Mar. 30, 2007

(30) Foreign Application Priority Data
Mar. 31, 2006 (JP) 2006-097598

(51) Int. Cl. B32B 15/00; B05D 5/12

(52) U.S. Cl. 428/692.1; 427/127

(57) ABSTRACT

A magnetic field generating method and a permanent magnetic circuit for, using magnetic field heat treatment, imparting axisymmetric anisotropy in a direction parallel to the substrate to a soft magnetic body, particularly a soft magnetic backing layer for a perpendicular two-layered magnetic recording medium used in perpendicular magnetic recording. In a rare earth permanent magnetic circuit that exhibits hardly any demagnetization at high temperature, a plurality of magnet side faces 95 orthogonal to pole faces 94 are disposed with space therebetween. A magnetic field that is substantially antiparallel to magnetization 91 is generated in the space, and an unprocessed sample is inserted. Further, the permanent magnetic circuit with the unprocessed sample inserted therein is placed in a heat treatment furnace, and the unprocessed sample is rotated 96 as desired.

### BACKGROUND OF THE INVENTION

1. Field of the Invention

The present invention relates to a permanent magnetic circuit, a magnetic field heat treatment apparatus, an axisymmetric magnetic field generating method and a manufacturing method for a perpendicular magnetic recording medium.

2. Description of the Related Art

In the field of magnetic recording, information recording by a hard disk apparatus as the primary external recording apparatus of computers including personal computers is indispensable. Following the improvement in the recording density of hard disk drives, development of the perpendicular magnetic recording system that enables higher density recording has been undertaken, in place of the conventional longitudinal magnetic recording system.

Regarding the perpendicular magnetic recording, basically the technology similar to that conventionally used can be applied to the recording medium and for the writing and reading involved in magnetic recording, although there are several differences.

In terms of the perpendicular magnetic recording media, a perpendicular two-layered magnetic recording medium having a soft magnetic backing layer 13 (typically, permalloy, amorphous CoZrTa, etc.; hereinafter, “SUL” (soft underlayer)) on a substrate 11, and a recording layer 14 (candidate materials include CoCrPt alloy, PtCo layer, PdFe film, PtFe film, amorphous SmCo film, etc.), a protective layer 15, a lubricating layer 16 and the like layered sequentially, as shown in FIG. 1A, has been extensively investigated, and is already becoming commercially viable. This layer configuration is peculiar to the perpendicular magnetic recording system. The SUL has the effect of increasing the write magnetic field, and is most effective in reducing demagnetization of the recording film.

The SUL in this perpendicular two-layer magnetic recording medium is required to be soft magnetic and to also have a thickness of roughly around 100 nm to 500 nm. Magnetic flux from the above recording layer passes though the SUL, as does writing flux from the recording head. Therefore, the SUL plays the same role as the iron yoke in a permanent magnetic circuit, and needs to be considerably thicker than the recording layer so as avoid becoming magnetically saturated during writing.

Depositing an SUL in a perpendicular two-layered recording medium is not easy in comparison to forming a nonmagnetic Cr underlayer 12 in a longitudinal recording medium as shown in FIG. 1B. Usually, the layers of a longitudinal recording medium are all formed using a dry process (primarily, magnetron sputtering) in the vicinity of 20 nm at most, as disclosed in JP H5-143972A.

Diverse investigations have been carried out into also using a dry process to form the recording layer and the SUL in the perpendicular two-layered recording medium. However, the SUL deposition using a dry process faces major problems in terms of mass productivity and yield.

In view of this, investigations have also been made into coating a core attaching film 17 (backing layer) made of a metal onto a nonmagnetic substrate using a plating technique that enables polishing and facilitates thick film deposition, as shown in FIG. 2.

The fact that imparting anisotropy usually in the radial or circumferential direction (being in the easy direction of magnetization) to the SUL is effective in reducing spike noise caused by the domain wall in the SUL is evident from the results of simulating the magnetic recording process. An anisotropic magnetic field Hk is schematically defined in FIG. 3.

When depositing the SUL with a dry process (e.g., sputtering), radial anisotropy is imparted to the SUL by applying a radial magnetic field to the substrate during the deposition process.

When depositing the SUL with a wet process (e.g., plating), circumferential anisotropy can be imparted by applying a unidirectional magnetic field to the substrate and rotating the substrate during the process of the plating deposition. This anisotropy is largely axisymmetric to the central axis of the substrate.

However, depositing an SUL with excellent film properties and imparting axisymmetric anisotropy at the same time is not easy whether the process is dry or wet, and controllability during the deposition process is also not good. A method that improves on this is thus sought.

Imparting radial or circumferential axisymmetric anisotropy to the SUL is not easy. This is because of the difficulty in creating a radial or circumferential magnetic field with a magnetic field apparatus that applies the magnetic field from outside. A radial magnetic field is possible with like poles of the coils opposed to each other, for instance, but the area in which an excellent radially divergent magnetic field is generated is small, and increasing the magnetic field strength is also difficult. Imparting axisymmetric anisotropy using magnetic field heat treatment has not been realized due to these restrictions in terms of generating a magnetic field.

### SUMMARY OF THE INVENTION

In the light of above current situation, an object of the invention is to provide a small permanent magnetic circuit with a simple configuration for using magnetic field heat treatment, imparting axisymmetric anisotropy to a soft magnetic body, particularly an SUL used in a perpendicular two-layered magnetic recording medium for perpendicular magnetic recording, and to provide a method for manufacturing a perpendicular magnetic recording medium with the permanent magnetic circuit.

The present invention has been completed for attaining the object. A permanent magnetic circuit for applying a magnetic field (hereinafter, simply referred to as “magnetic circuit”) according to the present invention may apply a magnetic field in a gap between opposing side faces of two or more rare earth permanent magnets, wherein the side faces may be orthogonal to pole faces of the magnets and the direction of the magnetic field generated in the gap may be opposite to a magnetization direction of the rare earth permanent magnets on the imaginary plane that may be parallel to the two opposing side faces of the magnets and may be equally distant from the two opposing side faces of the magnets, wherein the imaginary plane may be confined in a region formed by connecting four respective corresponding corners of two opposing side faces of the magnets, and its initial demagnetization when exposed to a temperature of 150° C. to 350° C. inclusive may be 5% or less.

A magnetic field thermal processing apparatus according to the invention may be obtained by disposing the above magnetic circuit set inside a heat treatment furnace.

A manufacturing method according to the present invention may be a method for manufacturing a perpendicular magnetic recording medium comprising a soft magnetic backing layer having an axisymmetric magnetic anisotropic distribution, a recording layer, a protective layer and a lubricating layer from a substrate side to an outer side. The manufacturing method may comprise the steps of: forming an unprocessed sample having on the substrate a soft magnetic backing layer comprising a soft magnetic material; inserting the unprocessed sample into the gap in the magnetic circuit, and aligning a center of the unprocessed sample with the rotational axis of the permanent magnetic circuit; and heat-treating the center-aligned unprocessed sample and the magnetic circuit inside a furnace at a desirable temperature. In this case, various intermediate films may be formed as necessary in order to strengthen and align the crystal grain diameter and the magnetic properties.

According to the present invention, a perpendicular magnetic recording medium can be obtained with anisotropy imparted thereto in an arbitrary direction such as the circumferential or radial direction, not limited to the application direction of the magnetic field, when a substrate with a soft magnetic backing layer formed thereon is heat-treated in a magnetic field.

A perpendicular two-layered magnetic recording medium in which an SUL may be used, as mentioned in the Background of the Invention, may be given as an example of a recording medium for perpendicular magnetic recording. Anisotropy may be usually imparted to the SUL at the same time as the deposition process, although controllability may be not good, as already mentioned above. By performing, separately to a SUL depositing step, an anisotropy processing step of heat-treating the SUL at a suitable temperature and atmosphere in a magnetic field using the magnetic circuit of the present invention in order to impart anisotropy to the SUL, controllability of the magnetic field for imparting anisotropy can be greatly improved, and production speed can also be improved.

Even if the magnetic field generated by the magnetic circuit is not axisymmetric, the same effect can be achieved, as the effect achieved by generating an axisymmetric magnetic field in time average, by aligning the center of the rotation of the unprocessed sample with the circuit axis of the magnetic circuit and relatively rotating the unprocessed sample around the circuit axis of the magnetic circuit.

### BRIEF DESCRIPTION OF THE DRAWINGS

FIGS. 1A and 1B are respectively schematic cross-sectional views showing a layer configuration of a perpendicular magnetic recording medium and a longitudinal magnetic recording medium.

FIG. 2 is an exemplary configuration of a substrate for a magnetic recording medium with a soft magnetic backing film formed thereon.

FIG. 3 is a schematic view showing the magnetic anisotropy of a soft magnetic backing film.

FIGS. 4A to 4C are schematic views showing the form of magnetic fields generated by permanent magnets.

FIGS. 5A and 5B are schematic views respectively showing the shape of axisymmetric magnetic fields typified by a radial magnetic field and a circumferential magnetic field.

FIG. 6 is a schematic view showing a radial magnetic field resulting from like poles opposed to each other.

FIG. 7 is a schematic view showing a circumferential magnetic field being generated around a conductive wire.

FIG. 8A is a schematic perspective view showing an embodiment of the magnetic circuit of the present invention with permanent magnets disposed so that the magnetic field direction in the gap between the magnets may be radially axisymmetric, while FIG. 8B is a cross-sectional view at a B-B cross-section of the magnetic circuit shown in FIG. 8A with unprocessed samples passed through by a support rod and set in the magnetic circuit.

FIG. 9A is a schematic perspective view showing an embodiment of the magnetic circuit of the present invention with permanent magnets disposed so that the magnetic field direction in the gap between the magnets may be circumferentially axisymmetric, while FIG. 9B is a cross-sectional view at a B-B cross-section of the magnetic circuit shown in FIG. 9A with unprocessed samples passed through by a support rod and set in the magnetic circuit.

FIGS. 10A and 10B are schematic perspective views respectively showing embodiments of the magnetic circuit of the present invention that enable axisymmetric anisotropy to be imparted radially and circumferentially by rotating unprocessed samples.

FIGS. 11A and 11B respectively show with vectors the direction and the amplitude of the magnetic flux generated in the gap in the magnetic circuits of FIGS. 8A and 9A.

FIG. 12 is a schematic view showing an embodiment of a method for fixing a sample.

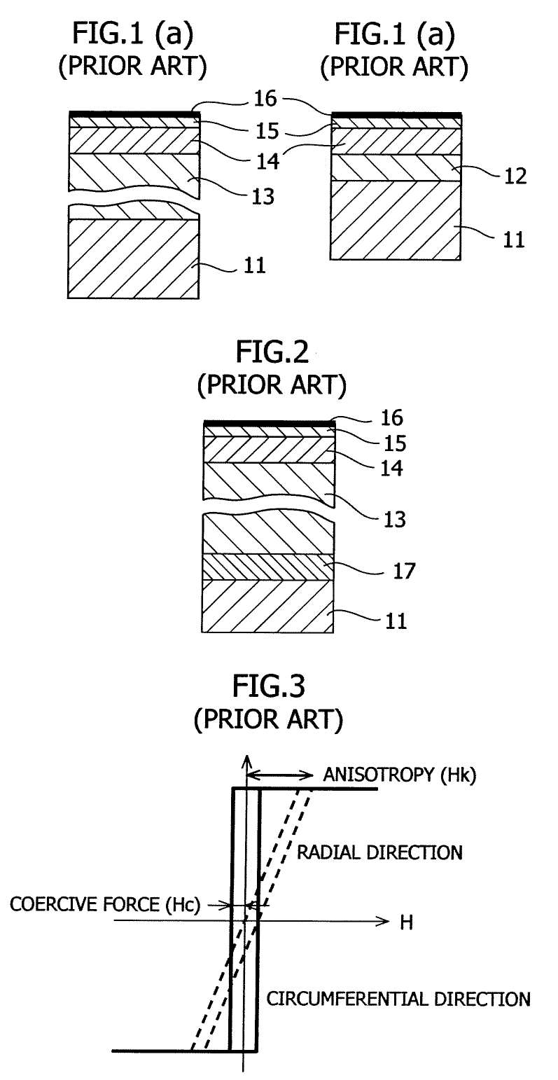

### DETAILED DESCRIPTION OF THE PREFERRED EMBODIMENTS

The inventors, having keenly investigated the methods of generating a magnetic field, invent a magnetic field generating method and a circuit for applying a largely axisymmetric magnetic field to an unprocessed sample, by placing a magnetic circuit with an initial demagnetization of 5% or less at a high temperature of roughly 150° C. to 350° C. inclusive, for example, in a heat treatment furnace, and generating a magnetic field close to the unprocessed sample. In the description, “unprocessed sample” indicates a sample to which a magnetic field has not yet been applied by a magnetic circuit of the present invention.

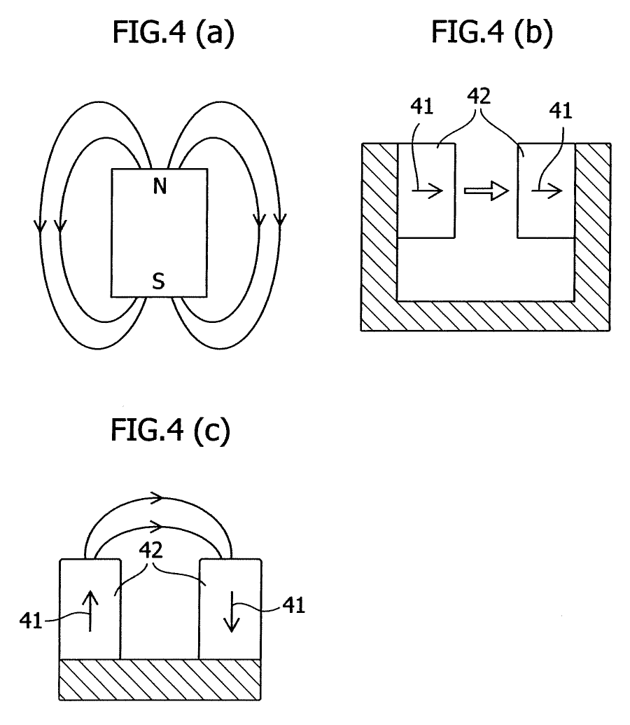

As for permanent magnets, particularly rare earth permanent magnets, anisotropic sintered magnets 42 with a specific magnetization direction 41 that have been obtained by sintering a raw material with c-axes aligned in a magnetic field are generally used. The magnetic flux of the anisotropic magnets exits the N pole face and enters the S pole face, as schematically shown in FIG. 4A. The NS pole faces are always a pair (dipole moment), and the amount of magnetic flux that exits and enters is balanced. Magnetic charge, unlike electric charge, cannot separate by itself, which places restrictions on the magnetic field distribution (including direction) that can be realized by permanent magnets.

Comparatively easy to realize is a unidirectional magnetic field generated between opposed pole faces via an iron yoke 43, as shown in FIG. 4B. A magnetic field distribution that curves between the poles, as shown in FIG. 4C, can also be easily generated.

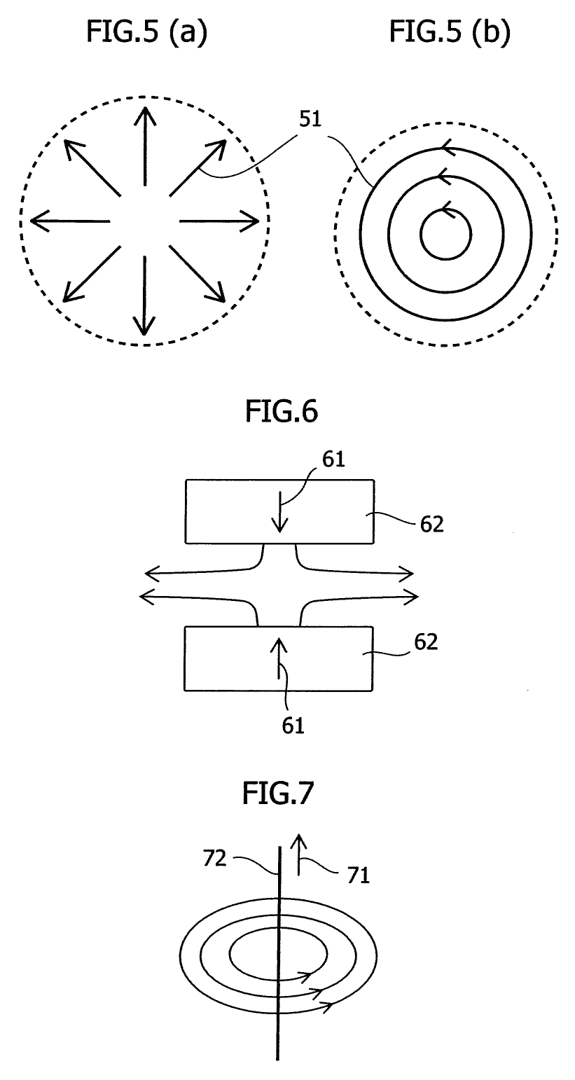

On the other hand, magnetic field distributions that are difficult to realize are a radial magnetic field (51) oriented radially in a given plane or a circumferential magnetic field (51) generated in a circular shape, as shown in FIGS. 5A and 5B. Regarding the former case, the difficulty is balancing the amount of polarity on the inner and outer sides of the diameter. Regarding the latter case, flux flow is basically trapped within the magnet, leaving nowhere for the magnet flux to exit, even when circumferential anisotropy can be imparted to a ring-shaped magnet. Thus, flux does not readily leak outside the magnet.

The following is a conceivable method for realizing an axisymmetric magnetic field distribution as noted above.

Firstly, to realize a radially symmetric magnetic field, the same magnetic poles of permanent magnets 62 or electromagnets are opposed to each other so that magnetization directions 61 are opposite, as shown in FIG. 6, and then by superposing the magnetic flux generated from respective pole faces together, a largely radially axisymmetric flux distribution is generated in a vicinity of the center plane of the gap between the magnets. This configuration of the magnetic circuit is actually being used for the sake of applying a magnetic field to a substrate with a sputtering apparatus or the like. Giving thought to the vicinity of the center plane with the same magnetic poles opposed to each other, the axial magnetic fields in proximity to the center plane negate each other, and the axial magnetic field strength is substantially zero, although a radial magnetic field is generated. However, the plane area in which the largely radial magnetic field is generated is limited to the proximity of the center plane. In plane areas that deviate from the proximity of the center plane, the perpendicular component of the magnetic field increases while the longitudinal component of the magnetic field decreases, and magnetic field strength distribution also increases. Since the longitudinal magnetic field component is required when manufacturing an anisotropic SUL film, plane areas that deviate greatly from the center plane are not desirable.

On the other hand, generating a circumferentially symmetric magnetic field is an even more difficult task than generating the radially symmetric magnetic field. Since the flux distribution lacks exiting or entering, realizing the flux distribution with permanent magnets is basically impossible. One possible and most desirable distribution is a rotating magnetic field occurring around a conductive line 72 that generates a DC current 71 as shown in FIG. 7. However, to obtain significant magnetic field strength (e.g., at least several hundred oersteds), the DC current must be extremely high (e.g., at least 10,000 A). Wile not impossible in principle, a large-scale power supply system of a magnitude required for aluminum electrolysis or the like becomes necessary. The need to handle high DC currents makes this method impractical due to the difficulties and dangers involved in terms also of the apparatus and system.

In a normal magnetic field heat treatment furnace, the processing quantity per batch is ensured by providing a magnetic field generating means outside the furnace body, and securing a large space for magnetic field heat treatment in the furnace core. The magnetic circuit with this conventional technique is large and heavy. Also, the furnace needs to be made of nonmagnetic material so that the constituent components of the furnace are not affected by the magnetic field, and the winding method needs rethinking so as to prevent the furnace heater from being affected by the magnetic field (Lorentz force is applied due to the magnetic field when current is generated). A large processing space is secured, but at the cost of the system becoming extremely complicated and large-scale.

From the above background, generating a radially or circumferentially axisymmetric magnetic field is extremely difficult, and it is hoped to realize these magnetic fields with a simple magnetic circuit.

The inventor finds it possible to generate a magnetic field that is largely antiparallel (opposite) to the magnetization direction, not in the space facing the pole faces of the permanent magnets but in the space formed between opposed magnet side faces which are largely orthogonal to the pole faces and invents a magnetic circuit using the same. Although the magnetic flux expands at the ends of the magnets, resulting in areas that are not completely opposite to the magnetization, the magnetic field is substantially opposite if these areas are excluded. Here, “pole face” is the face through which flux exits or enters. “Magnet side face” refers to the faces of a rare earth permanent magnet other than the pole face. The magnet side face preferably is orthogonal to the pole face.

Although very little flux leaks into the gap formed between opposed magnet side faces compared to the amount of flux that leaks into the gap between opposed pole faces, the inventors discovered that by controlling the gap interval, a magnetic field of 50 Oe or more, and around 100 Oe to 5 kOe in particular, could be generated at the center of the gap.

Expanding the interval between the magnet side faces dramatically reduces the magnetic field strength, however, so this interval preferably is kept at 100 mm or less, and more preferably 50 mm or less.

Particularly if the permanent magnet is a rare earth magnet, flux leakage from the side faces can be considered negligible, which makes the direction and strength of the gap flux easily controllable. The heat treatment in the magnetic field is carried out at a magnetic field strength of at least 50 Oe, preferably 100 Oe to 5 kOe, and more preferably 500 Oe to 5 kOe.

Accordingly, the magnetic circuit desirably is disposed so as to be close to an unprocessed sample to which the magnetic field will be applied or so as to sandwich an unprocessed sample. The unprocessed sample will be discussed later.

The rare earth magnets desirably have a high coercive force if the magnetic circuit is to be provided with heat resistance. With Nd—Fe—B sintered magnets, heat resistance of substantially 150° C. to 200° C. can be provided at a coercive force of 20 kOe or over, depending also on the magnetic circuit. Further, providing heat resistance of 200° C. or more is also possible if the coercive force is 30 kOe or more, although an increased reduction in saturation magnetization may result. The preferable upper limit is a coercive force of 50 kOe.

With 2:17 SmCo magnets, on the other hand, heat resistance of up to around 200° C. is securable at a coercive force of 10 kOe or more. In particular, provision of heat resistance exceeding 300° C. is also possible if the coercive force is 20 kOe or more, although the preferable upper limit can be set at 40 kOe.

2:17 SmCo magnets are suitable for use in magnetic field heat treatment of 200° C. or more, since the reversible temperature coefficient of saturation magnetization is around one quarter that of Nd—Fe—B magnets.

A block of magnet may be composed of a single magnet or segmented magnets may be integrated for use.

The use of adhesive in fixing the magnets is not preferable when assuming that the magnetic circuit of the present invention is used at the higher temperature of 150° C. or more, while the magnetic circuit of the present invention can also be used at the temperature below 150° C. Even with a heat resistant epoxy adhesive, maintaining adhesion and stability at temperatures exceeding 150° C. for an extended period is difficult. Volatile gas from the adhesive under high temperature may also adversely affect the unprocessed sample. Accordingly, the method of fixing the permanent magnets remains problematic.

Rare earth permanent magnets contain an intermetallic compound as a main phase, and are extremely brittle and difficult to tap. Since they cannot be bolted down, the magnets preferably are mechanically fixed.

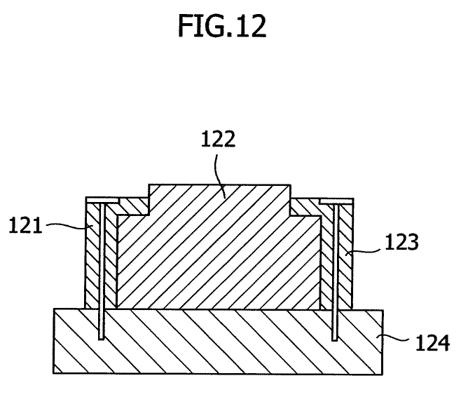

Here, “mechanically fixed” indicates that the positional relation of the interval between the side faces of the magnets and the magnetization direction is maintained without the use of adhesive or the direct use of screws, in a permanent magnetic circuit configured from two or more rare earth permanent magnets. Specifically, effective methods include providing steps in part of the magnet for holding the magnet down, or, as shown in FIG. 12, applying tapers 123 (nonmagnetic, magnetic) to the surface of a magnet 122 and fixing the magnet 122 to a support board 124 with nonmagnetic bolts 121.

Although the magnet faces may be left untreated, application of a metal coating or the like thereon is desirable. Since rare earth magnets are largely brittle, cracking or chipping may occur if the faces are held down directly. Application of a ductile metal coating such as Ni plating or Al ion plating is effective to prevent cracking or chipping.

By axisymmetically disposing the above permanent magnets over the surface of the same sample and providing an adequate gap between the magnets as appropriate, the inventors invented a magnetic circuit in which largely radial or circumferential magnetic fields can be separately created.

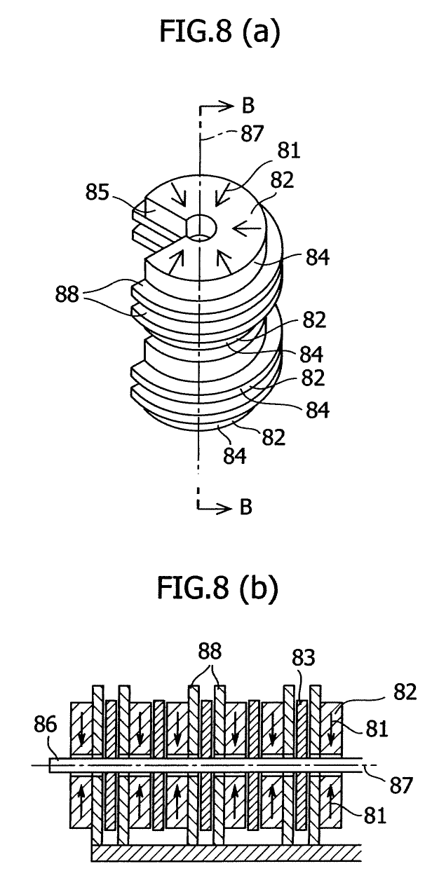

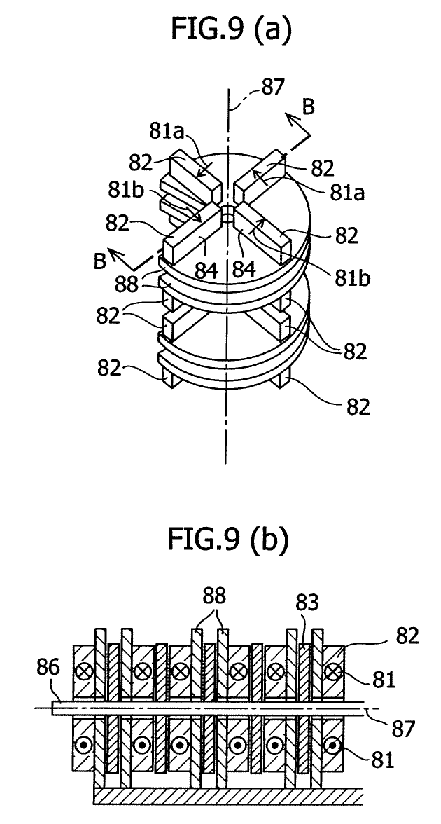

The simplest embodiments of the magnetic circuit of the present invention are shown in FIGS. 8A and 9A. The gap formed between opposed magnet side faces orthogonal to pole faces 84 is the space where the magnetic field is applied. These magnetic circuits can generate a magnetic flux opposite to the magnetization direction 81 of the permanent magnets in positions equally distant from any two opposing faces on a straight line connecting the intersection of the diagonals of the opposing magnet side faces. In FIGS. 8A and 9A, reference numeral 88 denotes a nonmagnetic support board.

The direction in which the magnetic field is applied to the unprocessed samples can be selected by choosing between the two types of magnetic circuits in the figures. If the unprocessed samples are disk-shaped, for example, FIG. 8A results in the application of a radial magnetic field, while FIG. 9A results in the application of a circumferential magnetic field.

In the case of applying a magnetic field in a direction intermediate between the radial and circumferential directions, the permanent magnets can be disposed so that the magnetization direction faces the intermediate direction.

The magnetic circuit of the present invention is able to compensate for the fact that the gap for applying the magnetic field is narrow by stacking plural pairs of permanent magnets 82 and providing a plurality of gaps, as shown in FIGS. 8B and 9B. Also, the magnetic circuit can be relatively small since it is provided in proximity to the unprocessed samples 83.

In the case of generating a radial magnetic field, one or a plurality (2 to 40) of permanent magnets with radial magnetization can be disposed on any one surface of a sample. If a plurality of permanent magnets are disposed, the magnets are disposed to be evenly spaced preferably.

In the case of generating a circumferential magnetic field, one or a plurality (2 to 6) of permanent magnets with circumferential magnetization can be disposed on any one surface of a sample.

If a plurality of permanent magnets are disposed, the magnets desirably are disposed over the same sample surface with an interval therebetween as shown in FIG. 9A, so that magnets do not interfere with each other, and so that short circuits do not occur between the magnets. The magnets are disposed to be evenly spaced preferably.

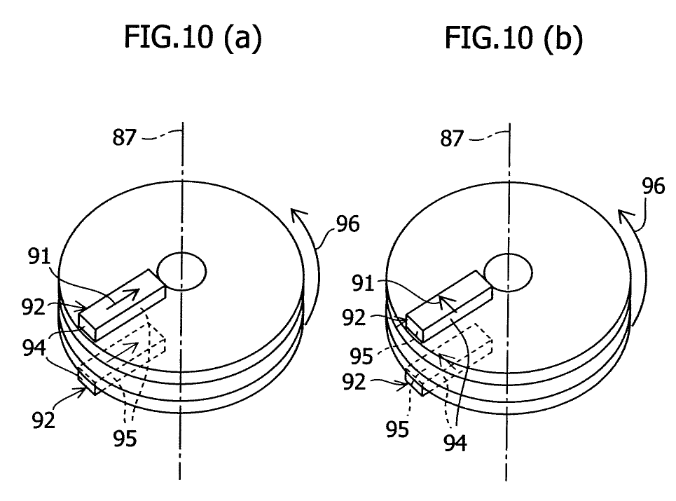

Magnetic circuits as shown in FIGS. 10A and 10B, for example, are conceivable in order to generate a radial or circumferential magnetic field in the case where a single permanent magnet with radial or circumferential magnetization is disposed. However, an axisymmetric magnetic field cannot be applied with these magnetic circuits, because the magnetic field generated in the gap formed between the opposed magnet side faces 95 orthogonal to the pole faces 94 of the permanent magnet 92 is not axisymmetric.

Expanding the disk-shaped permanent magnets in order to generate an axisymmetric magnetic field is conceivable, although it becomes difficult to achieve an appropriate positional arrangement with the unprocessed samples (discussed later) set in the gaps.

Also, if a permanent magnet with circumferential magnetization is expanded in a disk shape, the magnetic flux is largely trapped inside the magnet, resulting in the density of flux leaking into the space being extremely low.

Accordingly, further improvement is needed in an axisymmetric magnetic field generation.

In view of this, the inventor further invents a method that enables axisymmetric magnetic anisotropy to be imparted to the sample even when the magnetic circuit is not itself axisymmetric, with the object of facilitating the simplification of the magnetic circuit and the combining with the unprocessed sample (discussed later).

That is, by aligning an imaginary central axis 87 of the magnetic circuit in FIGS. 10A and 10B with a support rod 86 that fixes a preset unprocessed sample 93 by passing though a center position thereof, and rotating 96 the unprocessed sample 93 relatively, an axisymmetric magnetic field can be applied at any point on the concentric circumference of the unprocessed sample as seen in time average. Here, “imaginary central axis of the magnetic circuit” indicates the center of a magnetic circuit in which magnets are positioned radially from a central point.

The rotation 96 in the magnetic field can be performed together with the heat treatment. Since the heat treatment process is usually performed slowly for at least five minutes to several hours, an axisymmetric magnetic field is regarded as having been applied if the unprocessed sample is rotated relatively at a rotation speed of 5 rpm to 500 rpm inclusive. It may not be possible to obtain axisymmetry in time average at rotation speeds under 5 rpm, while the rotation mechanism may become complicated and axisymmetry increasingly difficult to obtain at rotation speeds in excess of 500 rpm. The preferable lower limit is a rotation speed of 10 rpm, while the preferable upper limit is a rotation speed of 150 rpm.

With the rotation, either the unprocessed sample or the magnetic circuit may be rotated, or both the unprocessed sample and the magnetic circuit may be rotated in opposite directions, although in terms of workability preferably the unprocessed sample is rotated.

As shown in FIG. 8A, the disposed permanent magnets may be provided with a cutout portion 85, in the case where magnetic anisotropy is imparted by rotation in a magnetic field,.

By providing the cutout portion 85, setting to align the support rod 86 with the imaginary central axis 87 of the magnetic circuit can be performed after inserting the support rod 86 through the unprocessed samples, which enables workability to be improved.

In the case where magnetic anisotropy is imparted using the rotation, one or a plurality of permanent magnets may be disposed over the surface of the same unprocessed sample.

A magnetic field heat treatment apparatus having a magnetic circuit of the present invention described above set in a heat treatment furnace is also one of the inventions.

Conventionally, magnetic field heat treatment was performed by providing a heat treatment furnace configured with nonmagnetic furnace components inside a magnetic field generating means composed of a magnetic circuit consisting of electromagnets or permanent magnets, or superconductive magnets or the like, and by generating a unidirectional magnetic field within the heat treatment furnace. However, the magnetic field generating means ends up being large-scale whatever the apparatus used, and the configuration of the heat treatment furnace tends to be complicated. The magnetic field heat treatment apparatus of the present invention is able to solve these problems.

An important issue concerning the magnetic field heat treatment apparatus of the present invention is the heat resistance of the magnetic circuit, given that the magnetic circuit is set inside the heat treatment furnace.

The temperature of the magnetic field heat treatment, while varying depending on the material used in the unprocessed samples, for instance, is often performed at roughly 150° C. to 350° C. inclusive. There is also virtually no thermal demagnetization of the magnetic circuit of the present invention in this temperature range; that is, irreversible demagnetization (initial demagnetization) preferably is 5% or less, and more preferably is 1% or less.

The inside of the furnace used in the magnetic field heat treatment is usually an inert gas atmosphere such as Ar, He or nitrogen.

In the description, irreversible demagnetization (initial demagnetization) refers to the demagnetization that occurs at the beginning of the holding period. It shows the rate of reduction in magnetic field strength generated by the magnetic circuit at the time after being heated and held for one hour, and the rate is measured by a gaussmeter.

An unprocessed sample suitably used in the manufacturing method for a perpendicular magnetic recording medium of the present invention has a soft magnetic backing layer including a soft magnetic material on a substrate.

While the substrate material is not particularly limited, Si single crystal, SiO₂ glass, aluminum or the like can be employed.

While the soft magnetic material included in the soft magnetic backing layer is not particularly limited, at least one member selected from the group consisting of Ni, Co and Fe can be employed.

The coercive force of the soft magnetic material included in the soft magnetic backing layer is usually 20 Oe or less, and preferably 0.1 Oe to 10 Oe.

The soft magnetic backing layer may be formed on the substrate using either a dry process such as sputtering or a wet process such as plating.

The thickness of the soft magnetic backing layer preferably is 10 nm to 1000 nm. The more preferable lower limit is a thickness of 50 nm, while the more preferable upper limit is a thickness of 500 nm.

The unprocessed sample is not particularly limited in shape provided it can be inserted into the gap in the magnetic circuit, although a disk shape or the like can be employed, for example. The disk shape is preferable in that the central axis is easy to define.

Hereinafter, the present invention will be described with reference to Examples. However, the present invention is not intended to be limited to them.

### TEST EXAMPLES 1 TO 9

Magnetic circuits (radial magnetic field) as shown in FIGS. 9A and 9B were manufactured with 2:17 SmCo magnets having flux density Br of 1.1 T (Tesla) and coercive force Hcj=20 kOe (kiro Oersted), and Nd—Fe—B magnets having Br of 1.25 T and Hcj of 25 kOe. These magnetic circuits had six magnet segments with radial magnetization direction disposed on a single substrate surface in the case of generating a radial magnetic field, and four magnet segments with circumferential magnetization direction disposed on a single substrate surface in the case of forming a circumferential magnetic field.

With both types of magnetic circuits, the magnetization direction of the opposing faces of the magnets is opposite to the direction of the magnetic field generated in the gap. The surface of the magnet segments is Ni-electroplated to prevent them from chipping. As shown in Table 1, the thickness of each magnetic surface ranges from 5 mm to 10 mm, while the gap between the magnet side faces ranges from 5 mm to 50 mm. Tapers (nonmagnetic bodies) as shown in FIG. 12 were provided to fix the magnets in place and prevent them from becoming dislodged. Five magnetic surfaces were disposed in an imaginary central axial direction of the magnetic circuits to provide four gaps. The results shown in Table 1 were obtained upon measuring magnetic field strength at the center position of the gap using a gaussmeter (model HGM-8900A, ADS Inc.).

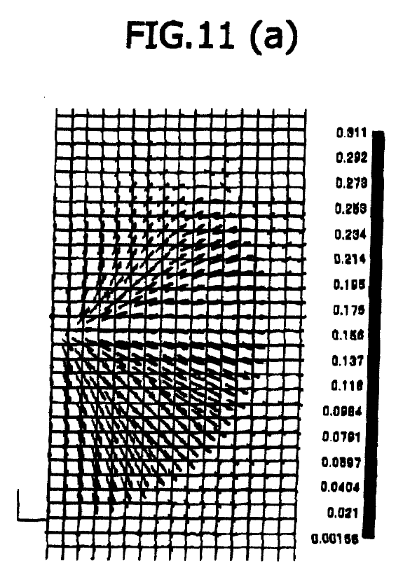

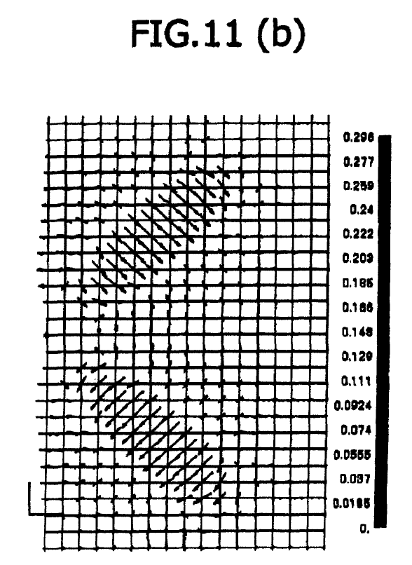

The direction of the magnetic flux, which was confirmed with magnetic measurement and simulation, was as shown in FIG. 11A in the radial direction, and as shown in FIG. 11B in the circumferential direction. These results reveal that the generated magnetic fields are substantially antiparallel to the magnetization direction of the permanent magnets (in positions equally distant from any two opposing faces on a straight line connecting the intersection of the diagonals of the opposing magnet side faces).

Also, having cooled the magnetic circuits to room temperature and measured the generated magnetic field after holding the magnetic circuits at respective temperatures for one hour, almost no irreversible demagnetization was evident (not more than 1% for all magnetic circuits). Exposure temperatures and irreversible demagnetization are likewise shown in Table 1.

| | | | | Mag. | | Exp. | |
|---|---|---|---|---|---|---|---|
| Test | Rare Earth | Thick. | Gap | Field | Mag. | Temp. | Irrev. |
| Eg. | Mag. | (mm) | (mm) | Str.(kOe) | Direct. | (° C.) | Demag.(%) |
| 1 | Nd—Fe—B | 5 | 5 | 3.5 | circum. | 160 × 1 hr | 0.8 |
| 2 | Nd—Fe—B | 5 | 5 | 4 | radial | 180 | 0.5 |
| 3 | Nd—Fe—B | 10 | 10 | 3.1 | radial | 200 | 0.9 |
| 4 | 2:17 SmCo | 5 | 5 | 3.4 | radial | 250 | 0.15 |
| 5 | 2:17 SmCo | 5 | 5 | 3 | circum. | 230 | 0.25 |
| 6 | 2:17 SmCo | 5 | 10 | 2.8 | radial | 250 | 0.1 |
| 7 | 2:17 SmCo | 5 | 20 | 1.2 | circum. | 250 | 0.25 |
| 8 | 2:17 SmCo | 10 | 20 | 1.7 | radial | 250 | 0.1 |
| 9 | 2:17 SmCo | 10 | 50 | 0.7 | radial | 300 | 0.7 |

Next, Ni/CoNiFeB was deposited in this order on Si(100) single crystals (p-doped n-type substrates) that were 65 mm in diameter to obtain SULs for perpendicular magnetic recording media, being the unprocessed samples. The coercive force of the SULs exhibited favorable soft magnetic properties of 4.5 Oe.

One SUL laminated substrate was disposed in each of the gaps in the magnetic circuits of test examples 2, 5 and 8 of Table 1, and the center position of the substrates was approximately aligned with the imaginary central axis of the respective magnet circuits. The substrates were then heat-treated for one hour at 200° C. in an Ar inert gas atmosphere, while each being rotated at 50 rpm and 120 rpm. Measuring the magnetic field characteristics of each of the substrates after being cooled revealed that magnetic anisotropy in the vicinity of 15 Oe to 25 Oe had been imparted over the entirety of each SUL laminated substrate in both the radial and circumferential directions. It was shown that excellent magnetic anisotropy with axisymmetricity could thereby be imparted to an SUL laminated substrate. This showed that the same effects as applying an axisymmetric magnetic field to an SUL laminated substrate are obtained by relatively rotating an SUL laminated substrate and a magnetic circuit that generates a unidirectional magnetic field.

What is claimed is:

1. A permanent magnetic circuit for applying a magnetic field in a gap between opposing side faces of two or more rare earth permanent magnets,
wherein the side faces are orthogonal to pole faces of the magnets and a direction of the magnetic field generated in the gap is opposite to a magnetization direction of the rare earth permanent magnets in a center equally distant from two opposing side faces on a central axis connecting an intersection of diagonals of the opposing magnet side faces, and irreversible demagnetization when exposed to a temperature of 150° C. to 350° C. inclusive is 5% or less.

2. The permanent magnetic circuit according to claim 1, wherein the rare earth permanent magnets are 2:17 SmCo magnets with a coercive force of at least 10 kOe, or Nd—Fe—B magnets with a coercive force of at least 20 kOe.

3. The permanent magnetic circuit according to claim 1, wherein the rare earth permanent magnets are mechanically fixed without using adhesive.

4. A magnetic field heat treatment apparatus comprising a permanent magnetic circuit as claimed in claim 1 inside a heat treatment furnace.

5. A method for generating an axisymmetric magnetic field comprising steps of:
inserting a disk-shaped sample that has a soft magnetic backing layer formed on a disk-shaped substrate into the gap in the permanent magnetic circuit as claimed in claim 1,
aligning the center of the disk-shaped sample with the rotational axis of the magnetic circuit, and
rotating the disk-shaped sample around the rotational axis.

6. A manufacturing method for a perpendicular magnetic recording medium comprising a substrate and layers formed on the substrate comprising a soft magnetic backing layer having an axisymmetric magnetic anisotropic distribution, a recording layer, a protective layer and a lubricating layer from a substrate side to an outer side, the method comprising the steps of:
forming an unprocessed sample comprising the substrate and the soft magnetic backing layer thereon comprising a soft magnetic material;
inserting the unprocessed sample into the gap in the permanent magnetic circuit as claimed in claim 1 so as to align the center of the unprocessed sample with a rotational axis of the permanent magnetic circuit; and
heat-treating the center-aligned unprocessed sample and the permanent magnetic circuit inside a furnace at a desirable temperature.

7. The manufacturing method for a perpendicular magnetic recording medium according to claim 6, further comprising a step of rotating the unprocessed sample around the central axis of the permanent magnetic circuit.

8. The manufacturing method for a perpendicular magnetic recording medium according to claim 6, wherein the unprocessed sample is disk-shaped.

9. The manufacturing method for a perpendicular magnetic recording medium according to claim 6, wherein the desirable temperature in the step of heat-treating is 150° C. to 350° C., and a magnetic field strength generated in the gap in the permanent magnetic circuit is 50 Oe or more at the center.
